(19) United States
(12) Patent Application Publication
(10) Pub. No.: US 2022/0317451 A1
(43) Pub. Date: Oct. 6, 2022

(54) OPTICAL UNIT AND HEAD-MOUNTED DISPLAY DEVICE USING THE SAME

(71) Applicant: Hitachi-LG Data Storage, Inc., Tokyo (JP)

(72) Inventors: Kotaro OOISHI, Tokyo (JP); Takahiro MOURI, Tokyo (JP)

(21) Appl. No.: 17/691,167

(22) Filed: Mar. 10, 2022

(30) Foreign Application Priority Data
Apr. 6, 2021 (JP) 2021-064783

(51) Int. Cl. G02B 27/01; G02B 26/08; G02B 27/28; G02B 5/30; F21V 8/00

(52) U.S. Cl. CPC G02B 27/0172; G02B 26/0808; G02B 26/0833; G02B 27/283; G02B 5/3016; G02B 6/002; G02B 2005/1804

(57) ABSTRACT

An optical unit of a head-mounted display device includes: a light-emitting unit configured to condense light emitted from a light source; a display unit configured to generate image light by using the light condensed in the light-emitting unit as illumination light; a projection lens configured to project the image light transmitted from the display unit; an optical axis conversion element configured to displace an optical axis of the image light projected from the projection lens; and a light-guide plate configured to receive the image light of which the optical axis is displaced by the optical axis conversion element, and to guide the image light to a wearer's pupil.

### CROSS-REFERENCE TO RELATED APPLICATION

The present application claims priority from Japanese application JP 2021-064783, filed on Apr. 6, 2021, the contents of which is hereby incorporated by reference into this application.

### BACKGROUND OF THE INVENTION

### 1. Field of the Invention

The present invention relates to a head-mounted display device (hereinafter, referred to as “HMD”) that projects and displays a virtual image.

### 2. Description of the Related Art

The HMD is a device that generates a virtual image in an eyeglass shape or a goggle shape, and displays an image. The HMD has an optical system configuration in which an image generated in a small panel is transmitted to eyes of an observer through an optical system such as a projection lens and a light-guide plate, and the size of an observation screen (FOV: field of view) that is observed by an observer is determined by a size of the small panel and an optical system design indicating how many times the observation screen is to be enlarged. Accordingly, in order to meet needs for enlarging the observation screen, it is necessary to enlarge the panel size or the optical system. In both the cases, a volume increases, and thus this is a problem in an HMD for which a reduction in size and weight is required.

As the related art in this technical field, specification of US 2018/0,172,994 A is exemplified. US 2018/0,172,994 A discloses a configuration in which an MEMS mirror and a diffraction grating are combined, and an angle of view is widened by widening an angle of view of light emitted from the MEMS mirror by the diffraction grating.

US 2018/0,172,994 A has a problem that resolution deteriorates in proportion to widening of the angle of view if a drawing speed of the MEMS does not vary.

### SUMMARY OF THE INVENTION

The invention has been made in consideration of the problem, and an object thereof is to provide an optical unit capable of enlarging a screen size without deterioration of resolution while realizing a reduction in size and weight, and an HMD using the optical unit.

According to an aspect of the invention, there is provided an optical unit of a head-mounted display device. The optical unit includes: a light-emitting unit configured to condense light emitted from a light source; a display unit configured to generate image light by using the light condensed in the light-emitting unit as illumination light; a projection lens configured to project the image light transmitted from the display unit; an optical axis conversion element configured to displace an optical axis of the image light projected from the projection lens; and a light-guide plate configured to receive the image light of which the optical axis is displaced by the optical axis conversion element, and to guide the image light to a wearer's pupil.

According to the invention, it is possible to provide an optical unit capable of enlarging a screen size without deterioration of resolution while realizing a reduction in size and weight, and an HMD using the optical unit.

### BRIEF DESCRIPTION OF THE DRAWINGS

FIG. 1 is a schematic external view of an HMD in an example;

FIG. 2 is a schematic functional configuration diagram of the HMD in the example;

FIG. 3 is a schematic configuration diagram of an image display unit in the example;

FIGS. 4A and 4B are views illustrating a configuration of a light-guide plate in the example;

FIGS. 5A and 5B are views illustrating an operation of an optical axis conversion element in the example;

FIGS. 6A and 6B are views illustrating enlargement display by using the optical axis conversion element in the example;

FIGS. 7A to 7C are views illustrating enlargement display at a magnification of four times by using the optical axis conversion element in the example;

FIGS. 8A and 8B are views illustrating a configuration in which a reflective mirror and a rotary mechanism are combined as a configuration of the optical axis conversion element in the example; and

FIG. 9 is a view illustrating a configuration using a liquid crystal panel as a configuration of the optical axis conversion element in the example.

### DETAILED DESCRIPTION OF THE PREFERRED EMBODIMENTS

Hereinafter, an example of the invention will be described in detail with reference to the accompanying drawings.

### Example 1

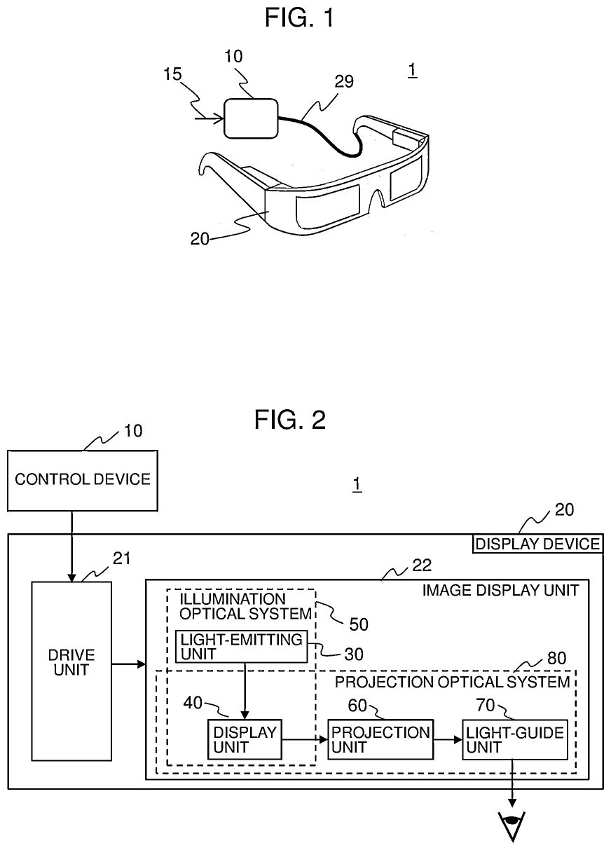

FIG. 1 is a schematic external view of an HMD in this example. In FIG. 1, an HMD 1 includes a control device 10 and a display device 20, and the control device 10 and the display device 20 are connected to each other through a cable 29. An image signal 15 to be displayed is transmitted from another customer terminal or the like, and is input to the control device 10. Then, a control command transmitted from the control device 10, and the image signal 15 are transmitted to the display device 20 through the cable 29, and image light is output in front of eyes of a wearer of the HMD 1 in the display device 20. Note that, FIG. 1 illustrates an eyeglass-shaped HMD. In addition, the control device 10 and the display device 20 may be integrated through the cable 29.

FIG. 2 is a schematic functional configuration diagram of the HMD in this example. In FIG. 2, the control device 10 transmits a control command and an image signal to the display device 20.

The display device 20 includes a drive unit 21, an image display unit 22 that is an optical unit. Note that, when one piece of the configuration of the image display unit 22 in FIG. 2 is provided, a monocular HMD is obtained, when two pieces of the configurations are provided, a binocular HMD is obtained, and the configuration in FIG. 2 is a configuration capable of corresponding to both the monocular HMD and the binocular HMD.

In FIG. 2, the image display unit 22 is provided with an illumination optical system 50 including a light-emitting unit 30 and a display unit 40, and a projection optical system 80 including the display unit 40, a projection unit 60, and a light-guide unit 70. Note that, the display unit 40 serves for both the illumination optical system 50 and the projection optical system 80.

The light-emitting unit 30 condenses light emitted from a light source and illuminates the display unit 40.

For example, the display unit 40 is a liquid crystal on silicon (LCOS), a digital light processing (DLP; registered trademark), or the like, and generates image light on which image information is superimposed by modulating light condensed in the light-emitting unit 30 as illumination light or by causing each pixel to emit or extinguish light on the basis of an image signal input from the control device 10 through the drive unit 21.

The projection unit 60 projects the image light transmitted from the display unit 40, and guides the image light to a wearer's pupil by the light-guide unit 70. The light-guide unit 70 is configured to allow the image light to arrive at the wearer's pupil even when a mounting position on the wearer deviates by duplicating and spreading the image light.

The drive unit 21 performs drive in combination with drive of the light source in the light-emitting unit 30 and transmission of the image signal to the display unit 40.

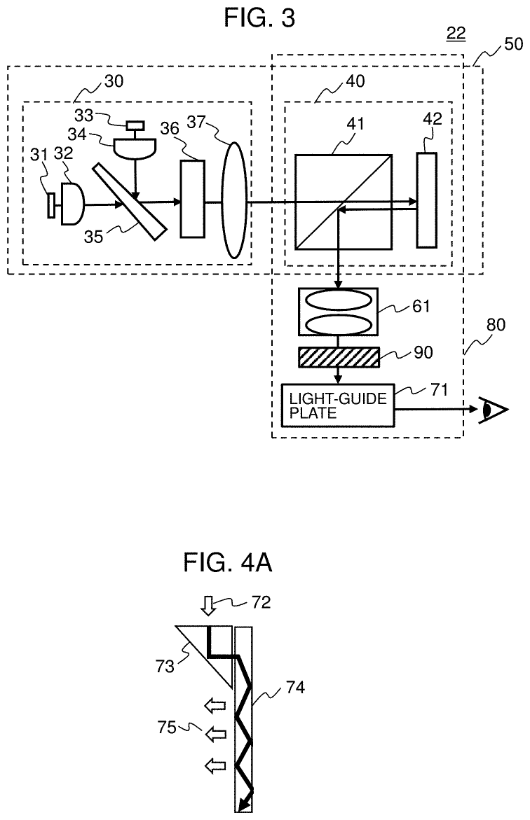

FIG. 3 is a schematic configuration diagram of the image display unit 22 in this example. In FIG. 3, as described above, the image display unit 22 is provided with the illumination optical system 50 including the light-emitting unit 30 and the display unit 40, and the projection optical system 80 including the display unit 40, a projection lens 61 constituting the projection unit 60, and a light-guide plate constituting the light-guide unit 70. Furthermore, an optical axis conversion element 90 is provided between the projection lens 61 and the light-guide plate 71.

The light-emitting unit 30 includes a light source 31, a light source 33, condensing lenses 32 and 34, a dichroic mirror 35, a microlens array (hereinafter, referred to as MLA) 36, and an imaging lens 37. Note that, in the light-emitting unit 30, a part of components may be omitted or another component may be added as long as an image display device 42 can be illuminated through a PBS 41.

In the light-emitting unit 30, the light source 31 emits green light (G-light). In the light source 33, a red light source and a blue light source are mounted in the same package, and the light source 33 emits red light and blue light (R-light and B-light). Note that, in FIG. 3, the light source 33 in which light sources of two colors are mounted in the same package is illustrated as an example, but light sources of three colors may be mounted in individual packages, or the light sources of three colors may be integrated and mounted in one package.

Light emitted from the light source 31 is incident to the condensing lens 32. The condensing lens 32 is arranged so that the light source 31 is located at a substantially combined focal position of the condensing lens 32. A luminous flux emitted from the light source 31 is incident to the condensing lens 32 and becomes collimated light. The collimated light transmitted from the light source 31 is emitted toward the dichroic mirror 35. Similarly, light emitted from the light source 33 is incident to the condensing lens 34 and becomes collimated light, and the resultant collimated light is emitted toward the dichroic mirror 35. The dichroic mirror 35 composes the R-light, the B-light, and the G-light by arranging optical axes thereof, and composes and emits collimated light of each color.

The MLA 36 is an optical lens in which lenses having a size of a micrometer unit are continuously arranged, and receives a substantially collimated luminous flux emitted from the dichroic mirror 35.

The luminous flux emitted from the MLA 36 is incident to the imaging lens 37. The imaging lens 37 condenses the collimated light and images the collimated light toward the PBS 41. Note that, an image to be imaged becomes an image in which images of openings of respective lenses provided on an incident side of the MLA 36 are superimposed on each other. Although an intensity distribution of light for illuminating the openings provided in the MLA 36 is not uniform, illumination light having a uniform intensity distribution can be provided to be superimposed on the imaging lens 37 in the subsequent stage, or the like.

The display unit 40 includes a polarizing beam splitter (PBS) 41, and an image display device 42. Note that, FIG. 3 illustrates a case where the image display device 42 is the LCOS.

The PBS 41 is an optical material composed of a transparent material and includes an incident surface, a reflective surface, and an emission surface. The reflective surface is inclined with respect to an optical axis of the imaging lens 37, and has a polarization-selective reflection performance. That is, the reflective surface reflects S-polarized light, but P-polarized light is transmitted therethrough. Therefore, in a case where a luminous flux transmitted from the imaging lens 37 is the P-polarized light, the luminous flux transmitted from the imaging lens 37 is transmitted through the reflective surface and illuminates the image display device 42.

The image display device 42 is the LCOS, and includes a liquid crystal layer and a display panel. The display panel reflects illumination light incident from the light-emitting unit 30. The liquid crystal layer modulates and operates polarized light of the illumination light incident from the light-emitting unit 30 on the basis of an image signal to control emitted light. According to this, the image display device 42 modulates light incident from the light-emitting unit 30 on the basis of the image signal to generate image light. The image light generated in the image display device is incident to the projection lens 61 constituting the projection unit 60 through the PBS 41.

The projection lens 61 projects an image of the image display device 42. The projection lens 61 provides the image of the image display device 42 as a virtual image so as to image the image of the image display device 42 on a retina in such a manner that the image exists at a desired distance from a user. Accordingly, the image light transmitted from the projection lens 61 is emitted to the light-guide plate 71 through the optical axis conversion element 90.

The light-guide plate 71 receives the image light generated by the image display device 42 from the projection lens 61, and guides the image light in front of eyes of the user by duplicating and spreading the image light through internal reflection.

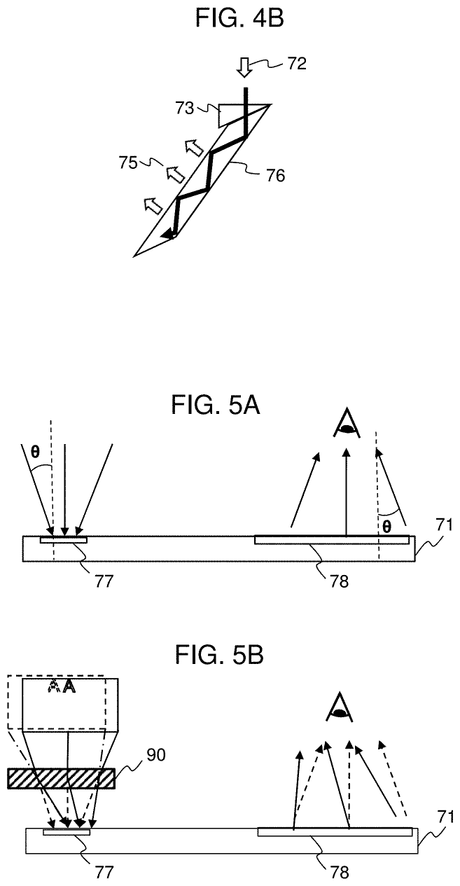

FIGS. 4A and 4B are views illustrating a configuration of the light-guide plate. In FIGS. 4A and 4B, FIG. 4A is a schematic view of a surface relief grating (SRG) type light-guide plate that is a light-guide plate using a diffraction element. Incident light 72 is incident to a SRG type light-guide plate 74 through a connection prism 73, and in the SRG type light-guide plate 74, diffraction and transmission are repeated by the diffraction element, and the incident light is duplicated to generate emission light 75. FIG. 4B is a schematic view of a beam splitter array (BSA) type light-guide plate. Incident light 72 is incident to a BSA type light-guide plate 76 through the connection prism 73, and in the BSA type light-guide plate 76, reflection and transmission are repeated by the beam splitter, and the incident light is duplicated to generate emission light 75.

In this example, a display area is enlarged by displacing an optical axis of small image light, which is incident light to the light-guide plate before duplicating and spreading the image light by the light-guide plate, by the optical axis conversion element 90. Particularly, in an optical system using a light-guide plate type, since an incident angle of the light-guide plate is restored in front of eyes, only angle conversion in the vicinity of an inlet of the light-guide plate may be performed. In addition, when performing the angle conversion at a high speed over observation capability of human beings, enlargement display becomes possible simultaneously over an entire screen. Hereinafter, details of screen enlargement in this example will be described.

FIGS. 5A and 5B are views illustrating an operation of the optical axis conversion element 90 in this example. In FIGS. 5A and 5B, FIG. 5A illustrates a relationship between incident light that is incident to an incident portion 77 of the light-guide plate 71, and emission light from light guiding and emitting region 78 that guides and emits the incident light. That is, the emission light is emitted from an emission portion by reproducing an incident angle θ of a light beam incident to an incident portion. Since eyes of human beings convert angle information into position information, in the light-guide plate, the position information of the incident light is reproduced by reproducing the incident angle of the incident light in the emission light.

FIG. 5B is a view illustrating the principle in which the angle information in the emission light is deviated by optical-axis converting the incident light by the optical axis conversion element 90, and according to this, the position information of the incident light is deviated. That is, an angle of a light beam of the incident light is changed by the optical axis conversion element 90 before being incident to the incident portion 77 of the light-guide plate 71. According to this, the light-guide plate reproduces a converted optical axis and emits the emission light from the light guiding and emitting region 78. For example, as illustrated in the drawings, in a case where an angle of the light beam after passing through the optical axis conversion element 90 varies from a dotted line to a solid line as illustrated, an observer who is viewing the emission light from the light guiding and emitting region 78 recognizes that a position of a display screen composed of the incident light which is “A” indicated by a solid line is changed to a display screen that is “A” indicated by a dotted line.

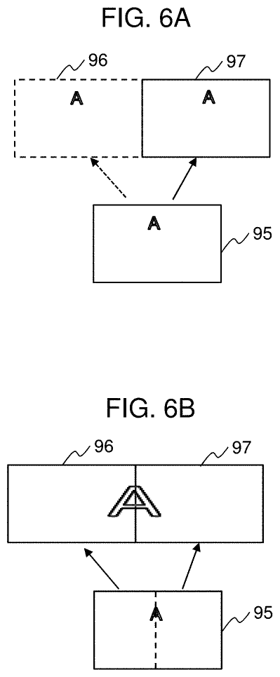

FIGS. 6A and 6B are views illustrating enlargement display using the optical axis conversion element 90 in this example. In FIG. 6A, when an optical axis of an image 95 composed of image light input to the optical axis conversion element 90 is displaced by an angle of view of the image 95 by the optical axis conversion element 90, it is possible to obtain display by an angle of view which is horizontally two times with an angle of view 96 before displacement and an angle of view 97 after displacement. Accordingly, as illustrated in FIG. 6B, when switching optical axes of divided images obtained by dividing the image 95 composed of the image light input to the optical axis conversion element 90 into a right part and a left part by using the optical axis conversion element 90 at a high speed, for example, at a period of a frame rate of 120 Hz, pseudo-enlargement display at a magnification of horizontally two times can be performed without perception to human beings. That is, when two divided images, which are obtained by dividing a predetermined image composed of image light generated by the image display device into two parts, are sequentially generated by the image display device 42, optical axes of the two divided images projected from the projection lens 61 are displaced by the optical axis conversion element 90 at angles different from each other to obtain an angle of view that is horizontally two times, and the resultant two divided images are input to the light-guide plate 71, an enlarged image that is two times the predetermined image can be generated. Note that, in this example, since a display region is enlarged while maintaining the number of pixels per angle of view, there is no deterioration of resolution.

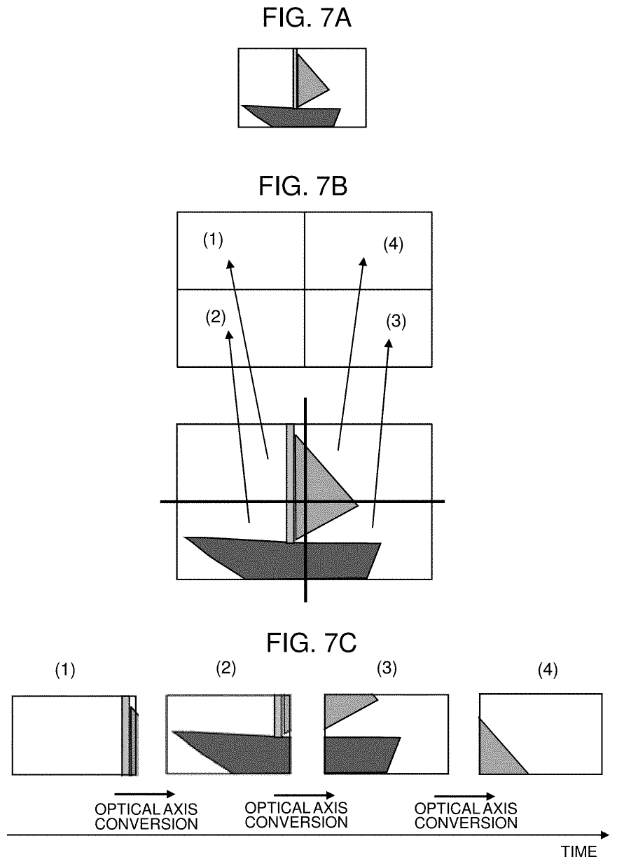

FIGS. 7A to 7C are views illustrating enlargement display at a magnification of four times by using the optical axis conversion element 90 in this example. FIG. 7A is an image 95 composed of image light input to the optical axis conversion element 90. In contrast, as illustrated in FIG. 7B, when optical axes of divided images (1), (2), (3), and (4) obtained by vertically and horizontally dividing the image 95 into four parts are switched by the optical axis conversion element 90 at a high speed, for example, at a period of a frame rate of 240 Hz as illustrated in FIG. 7C, pseudo-enlargement display at a magnification of four times can be performed without perception to human beings.

Note that, boundary portions of the divided images may be overlapped by several pixels in order to make a boundary inconspicuous. In this case, since brightness of the overlapping portion becomes uneven, for example, processing such as reducing the brightness of the overlapping portion may be performed on the LCOS side. Note that, when overlapping the boundary, there is an advantage that a change angle in optical axis variation can be made smaller in comparison to a case where the boundary is not overlapped.

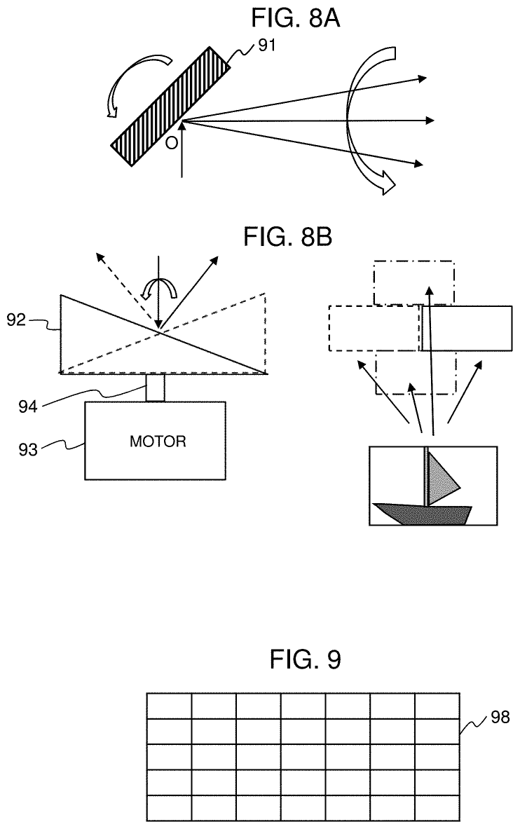

FIGS. 8A and 8B are views illustrating a configuration in which a reflective mirror and a rotary mechanism such as motor are combined as a configuration of the optical axis conversion element in this example. In FIGS. 8A and 8B, FIG. 8A illustrates a configuration in which the optical axis conversion element is an MEMS mirror 91, and the MEMS mirror 91 is rotated around a reflection point O to perform optical axis conversion. FIG. 8B illustrates a configuration in which the optical axis conversion element is a prism mirror 92, the prism mirror 92 is connected to a rotary shaft 94 of a motor 93, and the prism mirror 92 is rotated around the rotary shaft 94 to perform optical axis conversion. With regard to screen division, as illustrated in a right drawing, a screen may be vertically and horizontally divided.

Note that, control of optical axis rotation of the optical axis conversion element is performed by the control device 10, and the control may be performed, for example, on the basis of information transmitted from a mirror angle sensor.

FIG. 9 is a view illustrating a configuration using a liquid crystal panel as a configuration of the optical axis conversion element in this example. In FIG. 9, the optical axis conversion element is a liquid crystal panel 98, and a refractive index is changed by changing a voltage in each region-divided cell of the liquid crystal panel 98. According to this, a refractive index distribution of respective cells is created with respect to a direction in which an optical axis is desired to be bent, and a pseudo effect as in the mirror or the prism is obtained.

As described above, according to this example, when adding a mechanism that dynamically inclining an optical axis inside an HMD optical system, display possible region of a screen can be enlarged without enlarging an original optical system. According to this, it is possible to provide an optical unit capable of enlarging a screen size without deterioration of resolution while realizing a reduction in size and weight, and an HMD using the optical unit.

Hereinbefore, description has been given of the example, but the invention is not limited to the above-described example and is intended to include various modification examples. For example, the example has been described in detail for easy understanding of the invention, and it is not limited to including all of the above-described configurations.

What is claimed is:

1. An optical unit of a head-mounted display device, comprising:
a light-emitting unit configured to condense light emitted from a light source;
a display unit configured to generate image light by using the light condensed in the light-emitting unit as illumination light;
a projection lens configured to project the image light transmitted from the display unit;
an optical axis conversion element configured to displace an optical axis of the image light projected from the projection lens; and
a light-guide plate configured to receive the image light of which the optical axis is displaced by the optical axis conversion element, and to guide the image light to a wearer's pupil.

2. The optical unit according to claim 1,
wherein a plurality of divided images obtained by dividing a first image composed of the image light generated in the display unit are sequentially generated in the display unit, and the plurality of divided images projected from the projection lens are subjected to optical axis displacement at angles different from each other by the optical axis conversion element and are input to the light-guide plate to generate an enlarged image of the first image.

3. The optical unit according to claim 2,
wherein a period of the optical axis displacement for the plurality of divided images by the optical axis conversion element is at least 120 Hz.

4. The optical unit according to claim 3,
wherein the divided images are images obtained by dividing the first image into two parts, and
a period of the optical axis displacement for the two divided images by the optical axis conversion element is 120 Hz.

5. The optical unit according to claim 3,
wherein the divided images are images obtained by dividing the first image into four parts, and
a period of the optical axis displacement for the four divided images by the optical axis conversion element is 240 Hz.

6. The optical unit according to claim 1,
wherein the optical axis conversion element is a reflective mirror, and the optical axis of the image light is displaced by rotating the reflective mirror with a motor.

7. The optical unit according to claim 1,
wherein the optical axis conversion element is a liquid crystal panel, and the optical axis of the image light is displaced by changing a refractive index in each region-divided cell of the liquid crystal panel.

8. A head-mounted display device, comprising:
a control device; and
a display device,
wherein the display device includes a drive unit and an optical unit,
the optical unit includes,
a light-emitting unit configured to condense light emitted from a light source,
a display unit configured to generate image light by using the light condensed in the light-emitting unit as illumination light,
a projection lens configured to project the image light transmitted from the display unit,
an optical axis conversion element configured to displace an optical axis of the image light projected from the projection lens, and
a light-guide plate configured to receive the image light of which the optical axis is displaced by the optical axis conversion element, and to guide the image light to a wearer's pupil, and
optical axis displacement of the optical axis conversion element is controlled by the control device.

9. The head-mounted display device according to claim 8,
wherein a plurality of divided images obtained by dividing a first image composed of the image light generated in the display unit are sequentially generated in the display unit, and the plurality of divided images projected from the projection lens are subjected to optical axis displacement at angles different from each other by the optical axis conversion element and are input to the light-guide plate to generate an enlarged image of the first image.
